(19) United States
(12) Patent Application Publication
(10) Pub. No.: US 2014/0272864 A1
(43) Pub. Date: Sep. 18, 2014

(54) Metrics Engine for Virtual Reality Surgical Training Simulator

(71) Applicant: Peter KIM, Washington, DC (US)

(72) Inventor: Peter KIM, Washington, DC (US)

(21) Appl. No.: 14/063,300

(22) Filed: Oct. 25, 2013

Related U.S. Application Data
(60) Provisional application No. 61/790,573, filed on Mar. 15, 2013.

(51) Int. Cl. G09B 23/28

(52) U.S. Cl. CPC G09B 23/28
USPC 434/262

(57) ABSTRACT

Exemplary embodiments of a virtual reality surgical training simulator may be described. A virtual reality surgical training simulator may have a rendering engine, a physics engine, a metrics engine, a graphical user interface, and a human machine interface. The rendering engine can display a three-dimensional representation of a surgical site containing visual models of organs and surgical tools located at the surgical site. The physics engine can perform a variety of calculations in real time to represent realistic motions of the tools, organs, and anatomical environment. A graphical user interface can be present to allow a user to control a simulation. Finally, a metrics engine may be present to evaluate user performance and skill based on a variety of parameters that can be tracked during a simulation.

### CROSS REFERENCE TO RELATED APPLICATIONS

This application claims priority from U.S. Provisional Patent Application No. 61/790,573, filed Mar. 15, 2013, and entitled SYSTEM, METHOD, AND COMPUTER PRODUCT FOR VIRTUAL REALITY SURGICAL TRAINING SIMULATOR, the entire contents of which are hereby incorporated by reference.

### BACKGROUND

Simulation is a training technique used in a variety of contexts to show the effects of a particular course of action. Well-known simulators include computer flight simulators used to train pilots or for entertainment and even games like Atari's Battlezone, which was adapted by the U.S. Army to form the basis of an armored vehicle gunnery simulator. Simulators can range from simpler computer-based simulators configured to receive input from a single input device (e.g. a joystick) to complex flight simulators using an actual flight deck or driving simulators having a working steering wheel and a car chassis mounted on a gimbal to simulate the forces experienced while driving a car and the effects of various steering and command inputs provided through the steering wheel.

Surgical simulation platforms exist to allow for teaching and training of a variety of surgical techniques and specific surgical procedures in a safe environment where errors would not lead to life-threatening complications. Typical surgical simulation platforms can be physical devices that are anatomically correct models of an entire human body or a portion of the human body (for example, a chest portion for simulating cardiothoracic surgery or an abdomen portion for simulating digestive system surgery). Further, human analogues for surgical training can come in a variety of sizes to simulate surgery on an adult, child, or baby, and some simulators can be gendered to provide for specialized training for gender-specific surgeries (for example, gynecological surgery, caesarian section births, or orchidectomies/orchiectomies).

While physical surgical platforms are commonly used, physical simulation is not always practical. For example, it is difficult to simulate various complications of surgery with a physical simulation. Further, as incisions are made in physical surgical simulators, physical simulators may require replacement over time and can limit the number of times a physical simulator can be used before potentially expensive replacement parts must be procured and installed.

Virtual reality surgical simulation platforms also are available to teach and train surgeons in a variety of surgical procedures. These platforms are often used to simulate non-invasive surgeries; in particular, a variety of virtual surgical simulation platforms exist for simulating a variety of laparoscopic surgeries. Virtual reality surgical simulators typically include a variety of tools that can be connected to the simulator to provide inputs and allow for a simulation of a surgical procedure.

User interfaces for virtual reality surgical simulation platforms often rely on the use of a keyboard and pointing device to make selections during a surgical simulation. Further, graphical user interfaces for virtual reality surgical simulation platforms often present a multitude of buttons that limit that amount of screen space that can be used to display a simulation. Such interfaces can be unintuitive and require excess time for a user to perform various tasks during a simulation.

### SUMMARY

Exemplary embodiments of a virtual reality surgical training simulator may be described. A virtual reality surgical training simulator may have a rendering engine, a physics engine, a metrics engine, a graphical user interface, and a human machine interface. The rendering engine can display a three-dimensional representation of a surgical site containing visual models of organs and surgical tools located at the surgical site. The physics engine can perform a variety of calculations in real time to represent realistic motions of the tools, organs, and anatomical environment. A graphical user interface can be present to allow a user to control a simulation. Finally, a metrics engine may be present to evaluate user performance and skill based on a variety of parameters that can be tracked during a simulation.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary system diagram of a metrics engine for determining the quality of a simulated surgical procedure.

FIG. 2a shows an exemplary flow diagram of the first half of an algorithm for determining a score for a single parameter monitored during a simulated surgical procedure.

FIG. 2b shows an exemplary flow diagram of the second half of an algorithm for determining a score for a single parameter monitored during a simulated surgical procedure.

FIG. 3 shows a system diagram of a virtual reality surgical simulator.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

Referring exemplary FIG. 1, a metrics engine for use in a virtual reality surgical simulator may be disclosed. Metrics engine 100 may evaluate the performance of a user during a simulation session with respect to the expected actions for a specific surgical procedure, as calculated by a physics engine 10. Metrics engine 100 may monitor any number of parameters during a simulation based on a parameter list 102, which may be customized based on the skills to be evaluated and the type of surgical procedure being simulated. Metrics engine 100 may generate a score based on one or more measurement algorithms 104.

During a simulation, metrics engine 100 may gather raw simulation data as defined by parameter list 102. Metrics engine 100 may be configured to monitor a variety of simple and complex data statistics. For example, simple data statistics such as the amount of time and movement expended in performing a simulated surgical procedure can be gathered with little calculation. More complex performance metrics or parameters can also be monitored by metrics engine 100. In some embodiments, metrics engine 100 can be configured to evaluate the quality of a simulated procedure based on a comparison of a simulated resection and a predetermined optimal resection, the placement of incisions and predetermined optimal placements, and other qualitative parameters as desired. Further, metrics engine 100 may gather information about the amount of force imparted to soft tissue structures during surgery, the amount of tissue damaged during surgery, and other desired parameters. For each parameter defined by parameter list 102 and calculated by one or more measurement algorithms 104, metrics engine 100 may generate an indication of a user's proficiency in performing a surgical procedure. In an embodiment, such an indication may be a textual indication showing that a user has generated a failing score for a parameter, a level of proficiency for a parameter, or any other desired indication. Further, metrics engine 100 may generate a composite score based on a pre-determined weighting of each of the one or more parameters defined in parameter list 102. Individual scores and composite score may be displayed to a user of the virtual reality surgical simulator or may be stored in a computer memory, as desired.

Referring now to exemplary FIGS. 2a and 2b, a flow diagram showing the programmatic flow of an exemplary embodiment of a metrics algorithm 200 may be disclosed. Exemplary metrics algorithm 200 may continually monitor a parameter throughout a simulated surgical procedure. Each action may be given a raw score representing the quality of an action. Raw scores may be defined in parameter list 102, and metrics engine 100 may generate a score based on a user input compared to a predefined example for use in metrics algorithm 200. At the end of the surgical procedure, metrics algorithm 200 may generate a total raw score for a given parameter (for example, trocar placement in a laparoscopic procedure). Metrics algorithm 200 may generate a proficiency level and a phase score to be used in generating a composite score reflecting an assessment of a user's overall performance on a surgical scenario.

Referring to exemplary FIG. 3, metrics engine 100 may be a part of a virtual reality surgical simulator 300. Metrics engine 100 may be communicatively coupled with a physics engine 10, a processing system 20, and a rendering engine 30. Physics engine 10 may calculate the expected actions for a specific surgical procedure with input from a user. Processing system 20 may manage the flow of information and user commands in the virtual reality surgical simulator 300. Rendering engine 30 may render visuals of the simulation, for example to provide visual feedback to a user. Virtual reality surgical simulator 300 may also include an input device 40 and an output device 50. Input device 40 and output device 50 may be two separate devices or a single integrated device, as desired. In some exemplary embodiments, input device 40 may allow a user to log in, access records of simulations, and select a simulation to perform. In some exemplary embodiments, output device 50 may provide visual feedback to a user, for example, an image of a simulated surgery, the calculated records of completed simulations, or a score for how well a given simulated surgery was performed, as determined by the metrics engine.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A metrics engine for a virtual reality surgery simulator, comprising:
a central processor communicatively coupled to a memory;
a parameter list comprising at least one of evaluative parameters; and
a measurement algorithm;
wherein said central processor is also communicatively coupled to a physics engine, said physics engine being capable of calculating simulated surgical movements generated by a user of a human machine interface, and
wherein said measurement algorithm is capable of calculating a score, said score comparing said simulated surgical movements to said at least one of evaluative parameters.

2. A computer-implemented method for evaluating the performance of a user of a surgery simulator, comprising:
receiving simulated surgical movement data;
receiving at least one of evaluative parameters; and
using a measurement algorithm to calculate a score comparing said simulated surgical movement data and said at least one of evaluative parameters;
wherein said simulated surgical movement data is generated by a user of a human machine interface.

3. The computer-implemented method of claim 2, further comprising displaying said score to said user.

4. The computer-implemented method of claim 2, further comprising storing said score in a computer-readable medium.

5. The computer-implemented method for comparing a user's actions in a virtual reality surgical simulator with a pre-determined set of parameters, comprising:
performing the metrics algorithm substantially as shown and described.
